(19) United States
(12) Patent Application Publication
(10) Pub. No.: US 2016/0068693 A1
(43) Pub. Date: Mar. 10, 2016

(54) SUSTAINABLE RECYCLED MATERIALS FOR THREE-DIMENSIONAL PRINTING

(71) Applicant: XEROX CORPORATION, Norwalk, CT (US)

(72) Inventors: Ke Zhou, Oakville (CA); Guerino Sacripante, Oakville (CA)

(21) Appl. No.: 14/480,480

(22) Filed: Sep. 8, 2014

(51) Int. Cl. C09D 11/104

(52) U.S. Cl. CPC C09D 11/104; B33Y 70/00

(57) ABSTRACT

A sustainable material suitable for three-dimensional printing is disclosed. The sustainable material comprises a resin derived from recycled polyethylene terephthalate oligomer and a bio-based glycol. The resulting sustainable material provides a robust 3-D printing material.

### TECHNICAL FIELD

The present embodiments relate to three-dimensional (3-D) printing. More specifically, there is provided a sustainable recycled composition for use in applications related to printing 3-D objects.

### BACKGROUND

Three-dimensional (3-D) printing has been a popular method of creating various prototypes. There are several different methods of 3-D printing, but the most widely used and the least expensive is a process known as Fused Deposition Modeling (FDM). FDM printers use a thermoplastic filament, which is heated to its melting point and then extruded, layer by layer, to create a three dimensional object.

FDM printers use a printing material, which constitutes the finished object, and a support material, which acts as a scaffolding to support the object as it is being printed. The most common printing material for FDM is acrylonitrile butadiene styrene (ABS) which is a thermoplastic and has a glass transition temperature of about 105° C. Another common printing material for FDM is poly-lactic acid (PLA) which is a biodegradable thermoplastic aliphatic polyester derived from renewable resources and has a glass transition temperature 60-65° C. Both ABS and PLA are easily melted and fit into small molds.

There exists a need to develop different materials for use in FDM printers with more flexibility, higher Tg, or more environmental friendly materials such as those derived from recycled plastic, such that these printers may become more accessible and useful to the average consumer, as well as manufacturers.

### BRIEF SUMMARY

According to embodiments illustrated herein, there is provided a sustainable material suitable for three-dimensional printing (or a sustainable 3-D printing material) comprising a sustainable resin derived from a recycled polyethylene terephthalate (PET) (e.g., depolymerized PET waste bottles) and a bio-based glycol; and an optional a colorant.

In certain embodiments, the disclosure provides a sustainable 3-D printing material comprising a sustainable resin derived from a recycled polyethylene terephthalate oligomer and a bio-based glycol as illustrated in the reaction scheme below:

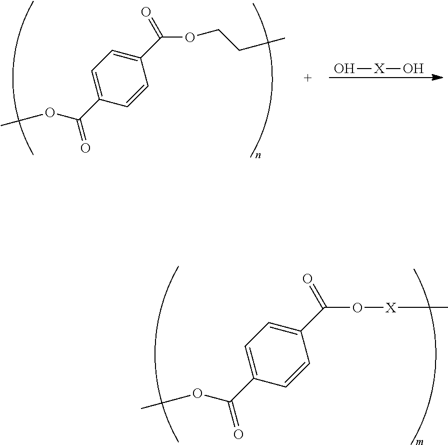

wherein n is from about 3 to about 20, m is from about 30 to about 100,000, and x is a substituted or unsubstituted alkyl group having from about 2 to about 6 carbon atoms.

### BRIEF DESCRIPTION OF THE DRAWINGS

FIG. 1 is a graph illustrating viscosity (Pa·s) over temperature (° C.) of a control polylactic acid (PLA) filament made by MakerBot (Brooklyn, N.Y.) as compared to a bio-derived resin according to the present embodiments; and

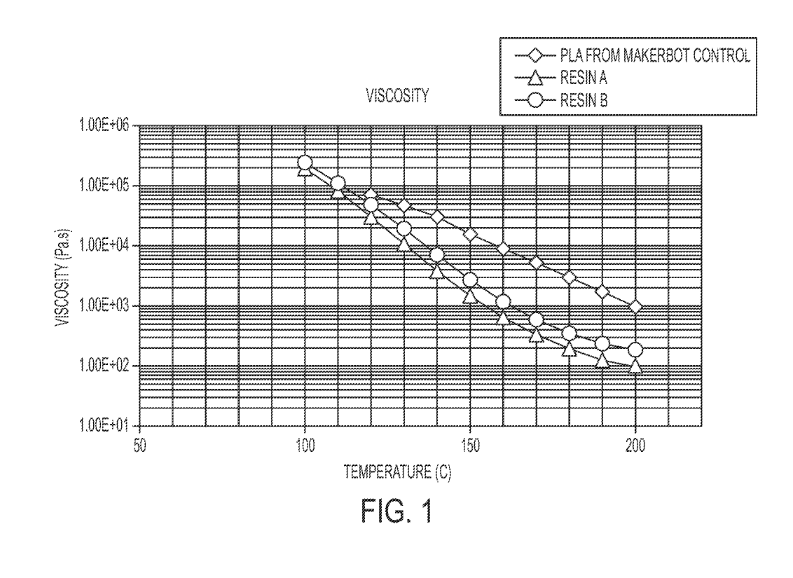

FIG. 2 is a tensile stress versus tensile strain graph of a sustainable material (Resin C) of the present embodiments.

FIG. 3 is a tensile stress versus tensile strain graph of a sustainable material (Resin D) of the present embodiments.

FIG. 4 is a tensile stress versus tensile strain graph of a sustainable material (Resin E) of the present embodiments.

### DETAILED DESCRIPTION

In the following description, it is understood that other embodiments may be used and structural and operational changes may be made without departing from the scope of the present disclosure.

The terms “optional” or “optionally” as used herein means that the subsequently described event or circumstance can or cannot occur, and that the description includes instances where a said event or circumstance occurs and instances where it does not.

The term “recycled” as used herein in connection with polymeric material, refers to polymeric material that is prepared from post-consumer polymeric material such as PET (e.g., recycled or waste bottles/plastic) and other consumer plastic materials. The term “polyethylene terephthalate” used herein is interchangeable with the term “recycled polyethylene terephthalate.” The recycled polyethylene terephthalate oligomer may be derived from the de-polymerization of PET with a glycol (e.g., ethylene glycol), in embodiments, as shown below:

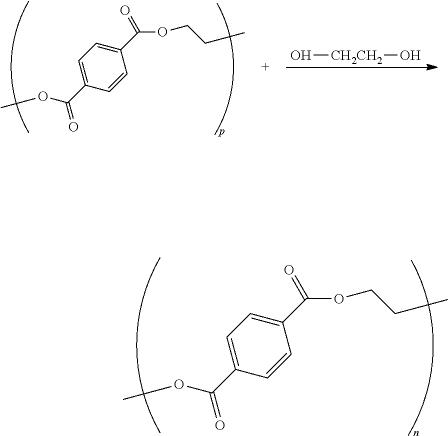

where p is from about 100 to about 100,000, and n is from about 3 to about 20.

The term “de-polymerization” as used herein refers to chemical feedstock recovery, or a process of breaking down plastics, such as PET, back into oligomers.

The term “polyethylene terephthalate oligomers” and “PETE” as used herein includes both PET polymers and copolymers that have been depolymerized, in certain embodiments, with ethylene glycol, to result in the aforesaid PETE oligomers of the general structure;

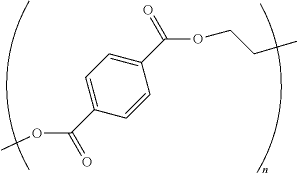

where n is about 3 to 20.

The terms “three-dimensional printing system,” “three-dimensional printer,” “printing,” and the like generally describe various solid freeform fabrication techniques for making three-dimensional objects by selective deposition, jetting, and fused deposition modeling.

The term “freezing” as used herein refers to the solidifying, gelling or hardening of a material during the three dimensional printing process.

Energy and environmental policies, increasing and volatile oil prices, and public/political awareness of the rapid depletion of global fossil reserves have created a need to find sustainable monomers derived from recycled plastics and biomaterials. Such monomers can be used for a wide field of applications.

The present embodiments disclose a sustainable recycled material suitable for 3-D printing including a recycled PET bottle by de-polymerization and an oligomer material (PETE). The term “sustainable” includes recycled or recyclable materials as well as biomass or bio-derived or bio-based materials. The terms “bio-derived” or “bio-based” are used to mean a resin comprised of one or more monomers that are derived from plant material. By using bio-derived feedstock, which are renewable, manufacturers may reduce their carbon footprint and move to a zero-carbon or even a carbon-neutral footprint. Bio-based polymers are also very attractive in terms of specific energy and emission savings. Utilizing bio-based feedstock can help provide new sources of income for domestic agriculture, and reduce the economic risks and uncertainty associated with reliance on petroleum imported from unstable regions.

The sustainable resin of the present embodiments may be derived from a polyethylene terephthalate (PET) and a bio-based glycol. PET may be a widely recycled plastic. PET plastics are coded with the resin identification code number “1” inside the universal recycling symbol. This code indicates that plastic products made of PET are picked up through most curbside recycling programs. PET bottles or plastics are characterized by high strength, low weight and permeability of gasses (mainly CO₂) as well as by their aesthetic appearance (good light transmittance, smooth surface).

In certain embodiments, a depolymerized product of recycled PET plastic may be a polyethylene terephthalate (PET) having a weight average molecule weight (MW) of from about 600 to about 5000, from about 600 to about 3000, from about 600 to about 1000, from about 700 to about 900, and from about 750 to about 850. In one embodiment, an example of a depolymerized product of recycled PET plastic may be a polyethylene terephthalate (PET) having a MW of about 800, such as a commercial product named Polylite A available from Reichhold Do Brazil LTDA.

The sustainable resin of the present embodiments may be derived from a recycled PET oligomer and a bio-based glycol (HO—X—OH) as illustrated in the reaction scheme below:

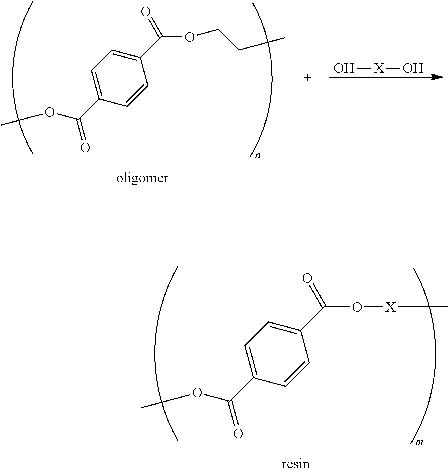

wherein n is from about 3 to 20, or from about 3 to 15, from about 3 to 10; m is from about 30 to 100,000, from about 100 to 50,000, or from about 100 to 10,000; x is a substituted or unsubstituted alkyl group having from about 2 to about 6 carbon atoms, from about 2 to about 5 carbon atoms, or from about 2 to 4 carbon atoms. In some embodiments, x may be a linear alkyl group. In some embodiments, x may be a branched alkyl group substituted with a methyl group. In some embodiments, x may be CH₂CH₂—, —CH (CH₃)CH₂—, CH₂CH₂CH₂CH₂CH₂—, or —CH(CH₃)CH₂CH₂—.

Examples of bio-based glycols employed for producing the present bio-derived resin includes, but are not limited to, 1,2-propylene glycol, 1,3-propylene glycol, ethylene glycol, 2-methyl-1,3-propanediol, 1,4-butylene glycol and mixtures thereof. The chemical structures of these bio-based glycols (HO—X—OH) are provided below:

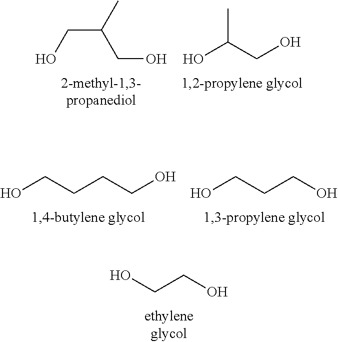

Examples of sustainable resins of the present disclosure include, but are not limited to, poly-(1,2-propylene-terephthalate), poly-(ethylene-terephthalate), poly-(1,3-propylene-terephthalate), poly-(1,4-butylene-terephthalate), poly-(2-methyl-1,3-propylene-terephthalate), co-poly (ethylene-terephthalate)-co-poly-(1,2-propylene-terephthalate), co-poly (ethylene-terephthalate)-co-poly-(1,3-propylene-terephthalate), co-poly (ethylene-terephthalate)-co-poly-(1,4-butylene-terephthalate), co-poly (ethylene-terephthalate)-copoly-(2-methyl-1,3-propylene-terephthalate) and mixtures thereof.

In one embodiment, the sustainable three-dimensional printing material comprises a sustainable resin derived from a bio-based 1,2-propylene glycol and a recycled polyethylene terephthalate oligomer, wherein the-sustainable resin is poly (1,2-propylene) terephthalate and has a structure of:

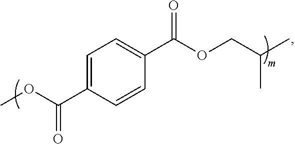

wherein m is from about 100 to about 100,000.

In another embodiment, the sustainable three-dimensional printing material comprises a sustainable resin derived from a bio-based 1,4-butane-diol and a recycled polyethylene terephthalate oligomer, wherein the-sustainable resin is poly (1,4-butylene) terephthalate and has a structure of:

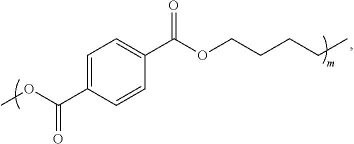

wherein m is from about 100 to about 100,000.

In another embodiment, the sustainable three-dimensional printing material comprises a sustainable resin derived from a bio-based 1,2-propylene glycol and a recycled polyethylene terephthalate oligomer, wherein the sustainable resin is copoly (ethylene-terephthalate)-co-poly-(1,2-propylene-terephthalate) and has the structure;

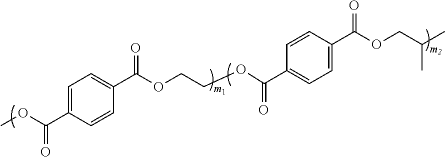

wherein m₁ and m₂ represent random segments of the polymer chain, and m1 is from about 10 to about 10,000 and m₂ is from about 10 to 100,000, wherein m₁+m₂ is within the range of 100 to 100,000.

In another embodiment, the sustainable three-dimensional printing material comprises a sustainable resin derived from a bio-based 1,4-butane-diol and a recycled polyethylene terephthalate oligomer, wherein the sustainable resin is co-poly (ethylene-terephthalate)-co-poly-(1,4-butylene-terephthalate) and has the structure;

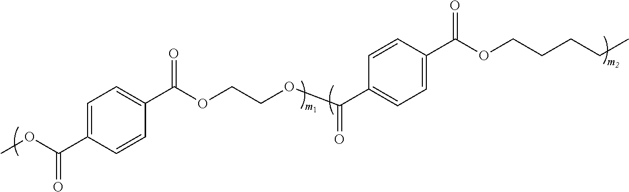

wherein m₁ and m₂ represent random segments of the polymer chain, and m₁ is from about 10 to about 10,000 and m₂ is from about 10 to 100,000, wherein m₁+m₂ is within the range of 100 to 100,000.

In embodiments, the sustainable resins may be derived from about 5 to about 60 percent by weight, from about 10 to about 40 by weight, or from about 10 to about 30 by weight of bio-based glycol, and from about 40 to about 95 percent by weight from about 60 to about 90 by weight, or from about 70 to about 90 by weight of recycled polyethylene terephthalate oligomer, provided that the sum of both is 100 percent.

In one embodiment, the sustainable resin of the present disclosure have a structure as shown below:

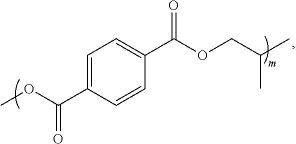

wherein m is from about 100 to about 100,000.

A sustainable resin described herein has a softening point and a freezing point consistent with the temperature parameters of one or more 3D printing systems. In some embodiments, a sustainable resin has a softening point ranging from about 140° C. to about 250° C., from about 150° C. to about 200° C., or from about 155° C. to about 185° C. In some embodiments, a sustainable resin has a freezing point ranging from about 10 C to about 100° C., from about 20° C. to about 75° C., or from about 25° C. to about 60° C.

The softening point (Ts) of the sustainable resin, can be measured by using the cup and ball apparatus available from Mettler-Toledo as the FP90 softening point apparatus and using the Standard Test Method (ASTM) D-6090. The measurement can be conducted using a 0.50 gram sample and heated from 100° C. at a rate of 1° C./min.

In some embodiments, the sustainable resin has a viscosity consistent with the requirements and parameters of one or more 3-D printing systems. In some embodiments, a bio-derived resin described herein has a viscosity ranging from about 100 centipoise to about 10,000 centipoise, from about 100 centipoise to about 1,000 centipoise, or from about 400 centipoise to about 900 centipoise at a temperature of about 150° C.

In some embodiments, the sustainable resin has a viscosity consistent with the requirements and parameters of one or more 3-D printing systems. In some embodiments, a sustainable resin described herein has a viscosity ranging from about 200 centipoise to about 10,000 centipoise, from about 300 centipoise to about 5,000 centipoise, or from about 500 centipoise to about 2,000 centipoise at a temperature of about 200° C.

In some embodiments, a sustainable resin has a Tg of from about 50° C. to about 120° C., from about 60° C. to about 100° C., or from about 65° C. to about 95° C.

The glass transition Temperature (Tg) and melting point (Tm) of the sustainable resin, can be recorded using the TA Instruments Q1000 Differential Scanning calorimeter in a temperature range from 0 to 150° C. at a heating rate of 10° C. per minute under nitrogen flow. The melting and glass transition temperatures can be collected during the second heating scan and reported as the onset.

In some embodiments, the sustainable resin has a Young's ranging from about from about 0.5 gigapascals (GPa) to about 5 GPa, from about 1 GPa to about 3 GPa, or from about 1 GPa to about 2 GPa.

In some embodiments, the sustainable resin has a Yield Stress ranging from about 10 megapascals (MPa) to about 100 MPa, from about 20 MPa to about 80 MPa, from about 40 MPa to about 65 MPa, or from about 40 MPa to about 60 MPa.

Young's modulus and Yield Stress can be measured using the 3300 Mechanical Testing Systems available from Instron, by the ASTM 638D method and using the sustainable resin filament of about 2 mm in diameter.

In some embodiments, a sustainable resin described herein is non-curable. The sustainable resin described herein is biodegradable.

The sustainable resin can be melt blended or mixed in an extruder with other ingredients such as pigments/colorants.

Typically, the sustainable resin of the present embodiments is present in the 3-D printing material in an amount of from about 85 to about 100 percent by weight, or from about 90 to about 100 percent by weight, or from about 95 to about 100 percent by weight of the total weight of the material. To obtain a clear 3-D printing material, 100% of the sustainable resin of the present embodiments may be used. To obtain a colored 3-D printing material having a color such as black, cyan, red, yellow, magenta, or mixtures thereof, the material may contain from about 3% to about 15%, from about 4% to about 10%, or from about 5% to about 8% of colorant by weight based on the total weight of the material. In certain embodiments, the sustainable 3-D printing material consist of two components namely a colorant and a sustainable resin of the present disclosure, as such the resin makes up the remainder amount by weight of the material.

The resulting recycled 3-D printing material of the present embodiments may include particles having a mean particle diameter of from 10 micrometers to 10 meters, from 10 micrometers to 1 meters, or from 100 micrometers to 0.3 meters.

As described above, the 3-D printing material can further comprise a colorant, and/or one or more additives.

Colorants

Various suitable colorants of any color can be present in the 3-D printing materials, including suitable colored pigments, dyes, and mixtures thereof including REGAL 330®; (Cabot), Acetylene Black, Lamp Black, Aniline Black; magnetites, such as Mobay magnetites MO8029™, MO8060™; Columbian magnetites; MAPICO BLACKS™ and surface treated magnetites; Pfizer magnetites CB4799™, CB5300™, CB5600™, MCX6369™; Bayer magnetites, BAYFERROX 8600™, 8610™; Northern Pigments magnetites, NP-604™, NP-608™; Magnox magnetites TMB-100™, or TMB-104™; and the like; cyan, magenta, yellow, red, green, brown, blue or mixtures thereof, such as specific phthalocyanine HELIOGEN BLUE L6900™, D6840™, D7080™, D7020™, PYLAM OIL BLUE™, PYLAM OIL YELLOW™, PIGMENT BLUE 1™ available from Paul Uhlich & Company, Inc., PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario, NOVAPERM YELLOW FGL™, HOSTAPERM PINK E™ from Hoechst, and CINQUASIA MAGENTA™ available from E.I. DuPont de Nemours & Company, and the like. Generally, colored pigments and dyes that can be selected are cyan, magenta, or yellow pigments or dyes, and mixtures thereof. Examples of magentas that may be selected include, for example, 2,9-dimethyl-substituted quinacridone and anthraquinone dye identified in the Color Index as CI 60710, CI Dispersed Red 15, diazo dye identified in the Color Index as CI 26050, CI Solvent Red 19, and the like. Other colorants are magenta colorants of (Pigment Red) PR81:2, CI 45160:3. Illustrative examples of cyans that may be selected include, copper tetra(octadecyl sulfonamido) phthalocyanine, x-copper phthalocyanine pigment listed in the Color Index as CI 74160, CI Pigment Blue, and Anthrathrene Blue, identified in the Color Index as CI 69810, Special Blue X-2137, and the like; while illustrative examples of yellows that may be selected are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Forum Yellow SE/GLN, CI Dispersed Yellow 33 2,5-dimethoxy-4-sulfonanilide phenylazo-4′-chloro-2,5-dimethoxy acetoacetanilides, and Permanent Yellow FGL, PY17, CI 21105, and known suitable dyes, such as red, blue, green, Pigment Blue 15:3 C.I. 74160, Pigment Red 81:3 C.I. 45160:3, and Pigment Yellow 17 C.I. 21105, and the like, reference for example U.S. Pat. No. 5,556,727, the disclosure of which is totally incorporated herein by reference.

The colorant, more specifically black, cyan, magenta and/or yellow colorant, is incorporated in an amount sufficient to impart the desired color to the 3-D printing material. In general, pigment or dye is selected, for example, in an amount of from about 2 to about 60 percent by weight, or from about 2 to about 9 percent by weight for color 3-D printing material, and about 3 to about 60 percent by weight for black 3-D printing material.

The recycled 3-D printing material of the present embodiments can be prepared by a number of known methods including melt mixing and extrusion of the sustainable resin, and an optional pigment particles or colorants. Other methods include those well known in the art such as flow able extrudate, with or without agitation, and brought to the desired operating temperature, typically above the initial melting temperature of the polymer, and then extruded and drawn to obtain the desired molecular orientation and shape.

### EXAMPLES

The examples set forth herein below are illustrative of different compositions and conditions that can be used in practicing the present embodiments. All proportions are by weight unless otherwise indicated. It will be apparent, however, that the present embodiments can be practiced with many types of compositions and can have many different uses in accordance with the disclosure above and as pointed out hereinafter. The resins used in these examples are defined below:

### Example 1

### Synthesis of Recycled PET Based Resin a

To a 1-L Buchi reactor was added 300 grams of depolymerized recycled PETE obtained from Reichhold, 116.40 grams of 1,2-propylene glycol and 2 grams of Sn catalyst Fascat 4100. The mixture was heated to 175° C. and maintained for 19 hours to allow trans-esterification between Propylene glycol and depolymerized PET. The mixture was then heated from 175° C. to 205° C. over a 90 min period and then vacuum was applied to remove excess propylene glycol and ethylene glycol to allow polycondensation. The experiment was monitored by softening point (Ts) measurement, and was discharged when the softening point reached 150.8° C.

### Example 2

### Synthesis of Recycled PET Based Resin B

To a 1-L Buchi reactor was added 300 grams of depolymerized recycled PET obtained from Reichhold, 116.40 grams of 1,2-propylene glycol and 2 grams g of Sn catalyst Fascat 4100. The mixture was heated to 175° C. and maintained for 19 hours to allow trans-esterification between Propylene glycol and depolymerized PET. The mixture was then heated from 175° C. to 205° C. over a 90 min period and then a vacuum was applied to remove excess propylene glycol and ethylene glycol to allow polycondensation. The experiment was monitored by softening point (Ts) measurement, and was discharged when the softening point reached 157.7° C.

### Example 3

Rheology of above resins were measured and compared with (polylactic acid) PLA filament for 3D printing made by MakerBot (Control). It shows that current PLA 3D material on market has very high viscosity. Increasing the final Ts from 150.8° C. (Resin A—Example 1) to 157.7° C. (Resin B—Example 2) allowed the resin viscosity to be closer to the control PLA material. It is believed that by further increasing resin and the final Ts, a sustainable material for 3D printing can be obtained.

Rheology was measured with AR2000 Advanced Rheometer. The sustainable resin sample was melted into pellets of 25 mm in diameter, and measured with EHP-25 mm steel parallel plates using temperature sweep test methods from 100 to 200° C. at a heating rate of 1° C./min.

It will be appreciated that variations of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### Example 4

### Synthesis of Recycled PET Based Resin C

To a 1-L Parr reactor equipped with a mechanical stirrer, distillation apparatus and a bottom drain valve, was added 604.73 grams of depolymerized recycled PET from Reichhold, Inc., 28.42 grams of 1,4 butanediol and 2 grams of Sn catalyst Fascat® 4100. The mixture was heated to 160° C. under a nitrogen purge (1 scfh), and then slowly increased to 195° C. over a 3 hour period and maintained for an additional 18 hours to allow trans-esterification between 1,4-butanediol and depolymerized PET. The mixture was then heated from 190° C. to 210° C. over a 1 hour period and then a vacuum was applied to remove excess 1,4-butanediol to allow polycondensation. The mixture was then heated at 215° C., while under vacuum, until a softening point of 175° C. was reached.

### Example 5

### Synthesis of Recycled PET Based Resin D

To a 1-L Parr reactor equipped with a mechanical stirrer, distillation apparatus and a bottom drain valve, was added 604.18 grams of depolymerized recycled PET from Reichhold, Inc., 56.80 grams of 1,4 butanediol and 2.01 grams of Sn catalyst Fascat® 4100. The mixture was heated to 160° C. under a nitrogen purge (1 scfh), and then slowly increased to 195° C. over a 3 hour period and maintained for an additional 18 hours to allow trans-esterification between 1,4-butanediol and depolymerized PET. The mixture was then heated from 190° C. to 210° C. over a 1 hour period and then a vacuum was applied to remove excess 1,4-butanediol to allow polycondensation. The mixture was then heated at 250° C., while under a vacuum, until a softening point of 173.4° C. was reached.

### Example 6

### Synthesis of Recycled PET Based Resin E

To a 1-L Parr reactor equipped with a mechanical stirrer, distillation apparatus and a bottom drain valve, was added 580.01 grams of depolymerized recycled PET from Reichhold, Inc., 81.96 grams of 1,4 butanediol and 2.01 grams of Sn catalyst Fascat® 4100. The mixture was heated to 160° C. under a nitrogen purge (1 scfh), and then slowly increased to 195° C. over a 3 hour period and maintained for an additional 18 hours to allow trans-esterification between 1,4-butanediol and depolymerized PET. The mixture was then heated from 190° C. to 210° C. over a 75 minute period and then a vacuum was applied to remove excess 1,4-butanediol to allow polycondensation. The mixture was then heated at 250° C., while under a vacuum, until a softening point of 181.3° C. was reached.

### Example 7

### Preparations of the Resin Filaments

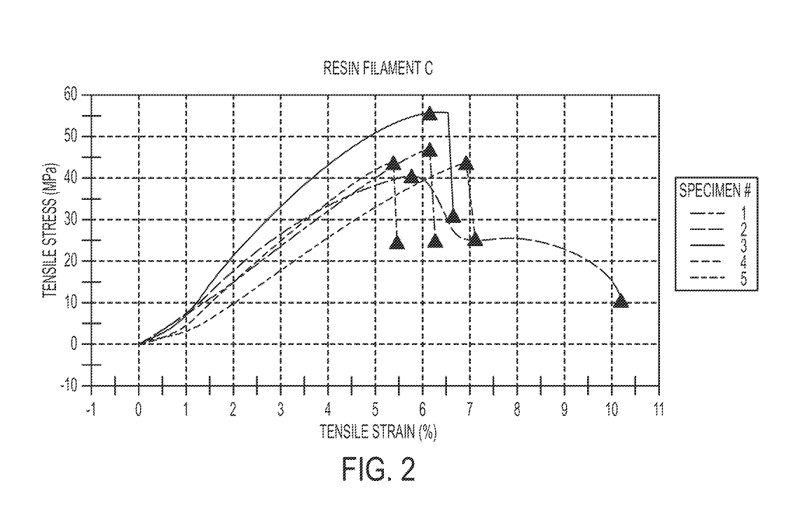

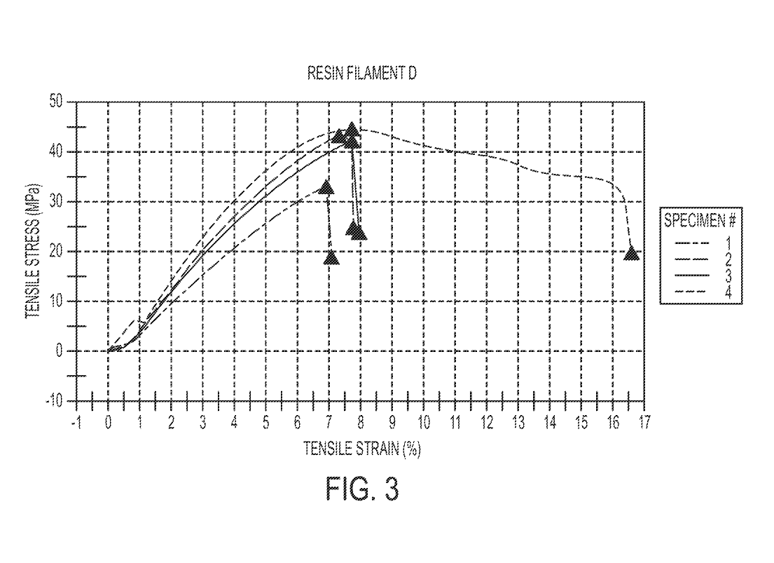

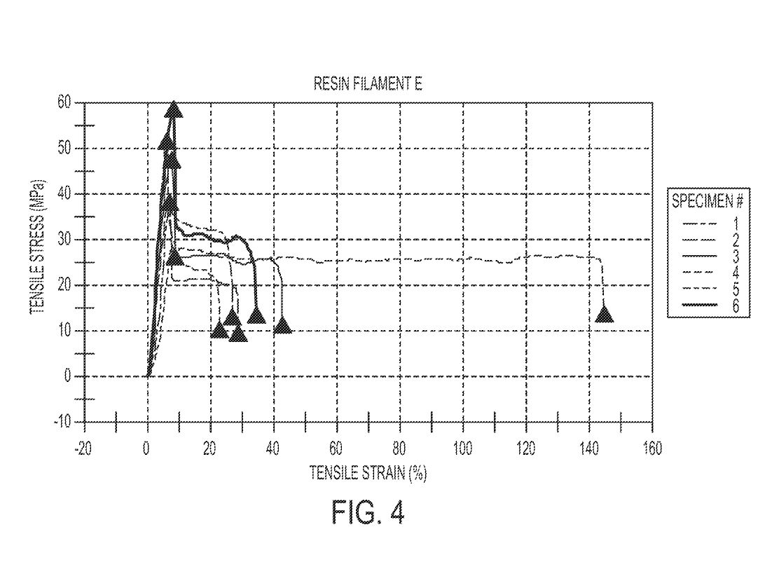

Resin filaments C, D and E were prepared using the Melt Flow Index (MFI) instrument. The sample of each of the resins obtained from Examples 4 (Resin Filament C), Example 5 (Resin Filament D), Example 6 (Resin Filament E), 7 were melted separately in a heated barrel and extruded through an orifice of a specific diameter, under a certain weight. The resulting resin filaments are flexible and hard. The mechanical properties of the resin filaments were measured using the Instron Tensile Testing System and compared with the commercial ABS (acrylonitrile butadiene styrene) and PLA (Example 3) 3-D materials. The results are shown in FIGS. 2-4 illustrating the tensile stress-strain relationship of the materials, which are similar to the Instron results of the commercial 3D materials. Table 1 below shows the yield stress, yield strain, breaking strain and breaking stress for the Resin filaments C, D, E and the controls ABS and PLA (true black color).

TABLE 1
Instron comparison of Resin filaments
C, D and E with commercial 3D materials

| | | Yield | Yield | Breaking | Breaking |
|---|---|---|---|---|---|
| | PET/ | stress | strain | strain | stress |
| Resin Filaments | butanediol | (MPa) | (%) | (%) | (MPa) |
| Control: ABS | — | 41.62 | 4.85 | 65 | 20.16 |
| Control: PLA | — | 67.87 | 5.31 | 26 | 28.82 |
| True Black | | | | | |
| C | 90/10 | 46.02 | 6.07 | 7.13 | 23.4 |
| D | 80/20 | 40.69 | 7.41 | 9.84 | 21.78 |
| E | 70/30 | 44.42 | 7.05 | 49.95 | 12.65 |

What is claimed is:

1. A sustainable three-dimensional printing material comprising a sustainable resin and an optional colorant, wherein the sustainable resin is derived from a bio-based glycol and a recycled polyethylene terephthalate oligomer.

2. The material of claim 1, wherein the sustainable resin is derived from about 5 to about 60 percent by weight of bio-based glycol, and from about 40 to about 95 percent by weight of recycled polyethylene terephthalate oligomer, provided that the sum of both is 100 percent.

3. The material of claim 1, wherein the recycled polyethylene terephthalate oligomer has a weight average molecule weight (MW) of from about 600 to about 5000.

4. The material of claim 1, wherein the recycled polyethylene terephthalate oligomer has a formula of: 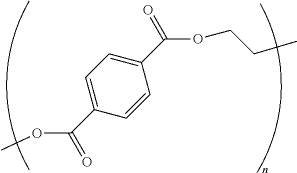
wherein n is from about 3 to about 20.

5. The material of claim 1, wherein the recycled polyethylene terephthalate oligomer is derived from the de-polymerization of PET recycled plastic with a glycol.

6. The material of claim 1, wherein the bio-based glycol is selected from the group consisting of 1,2-propylene glycol, 1,3-propylene glycol, ethylene glycol, 2-methyl-1,3-propanediol, 1,4-butane-diol and mixtures thereof.

7. The material of claim 1, wherein the sustainable resin is selected from the group consisting of poly-(1,2-propylene-terephthalate), poly-(1,2-ethylene-terephthalate), poly-(1,3-propylene-terephthalate), poly-(1,4-butylene-terephthalate), poly-(2-methyl-1,3-propylene-terephthalate), co-poly (ethylene-terephthalate)-co-poly-(1,2-propylene-terephthalate), co-poly (ethylene-terephthalate)-co-poly-(1,3-propylene-terephthalate), co-poly (ethylene-terephthalate)-co-poly-(1,4-butylene-terephthalate), co-poly (ethylene-terephthalate)-co-poly-(2-methyl-1,3-propylene-terephthalate) and mixtures thereof.

8. The material of claim 5, wherein the bio-based glycol comprises 1,4-butane-diol.

9. The material of claim 5, wherein the bio-based glycol comprises 1,2-propylene glycol.

10. The material of claim 1, wherein the resin has a softening point of from about 140° C. to about 200° C.

11. The material of claim 1, wherein the resin has a freezing point of from about 20° C. to about 100° C.

12. The material of claim 1, wherein the resin has a viscosity of from about 200 centipoise to about 10,000 centipoise at 100° C. to about 200° C.

13. The material of claim 1, wherein the resin has a Tg of from about 50° C. to about 90° C.

14. The material of claim 1, wherein the resin is present in the sustainable material in an amount of from about 85% to about 95% by weight.

15. The material of claim 1, wherein the optional colorant is present in the sustainable material in an amount of from about 3% to about 15% by weight.

16. The material of claim 1, having a Young's Modulus of from about 0.5 to about 5 gigapascals.

17. The material of claim 1, having a Yield Stress of from about 10 to about 100 megapascals.

18. A sustainable three-dimensional printing material comprising:
a sustainable resin derived from a recycled polyethylene terephthalate oligomer and a bio-based glycol as illustrated in the reaction scheme below: 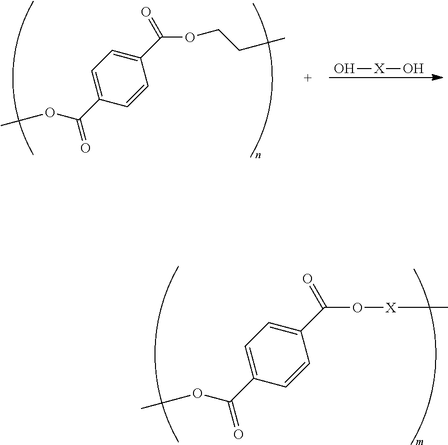
wherein n is from about 3 to about 20, m is from about 30 to about 100,000, and x is a substituted or unsubstituted alkyl group having from about 2 to about 6 carbon atoms.

19. The material of claim 1, wherein x is selected from the group consisting of —CH₂CH₂—, —CH(CH₃)CH₂—, CH₂CH₂CH₂CH₂CH₂—, and —CH(CH₃)CH₂CH₂—.

20. The material of claim 1, wherein the sustainable resin has a structure of: 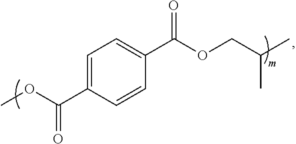
wherein m is about 100 to about 100,000.
